(19) United States
(12) Patent Application Publication
(10) Pub. No.: US 2010/0054631 A1
(43) Pub. Date: Mar. 4, 2010

(54) IMAGE PROCESSING APPARATUS, IMAGE PROCESSING METHOD, AND STORAGE MEDIUM

(75) Inventor: Tateki Narita, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/548,515

(22) Filed: Aug. 27, 2009

(30) Foreign Application Priority Data
Aug. 27, 2008 (JP) 2008-218103

(51) Int. Cl. G06K 9/54

(52) U.S. Cl. 382/305

(57) ABSTRACT

An image processing apparatus enables to cause a user to certainly and quickly recognize a not-supported image file. A first determining unit determines whether image data capable of being image-processed is included in an image file including a plurality of pieces of image data obtained from outside. An adding unit adds device information including information of non-support to a file header of the image file when the first determining unit determines that image data incapable of being image-processed is included. A second determining unit determines whether the device information is included in file header information of the image file obtained from outside. An image-processing unit image-processes the image file which has been determined by the first determining unit to include image data capable of being image-processed, and the image file which has been determined by the second determining unit not to include the device information in the file header information.

### BACKGROUND OF THE INVENTION

1. Field of the Invention

The present invention relates to an image processing apparatus and an image processing method for processing an image file obtained from an external storage apparatus, and a computer-readable storage medium having a program for implementing the method stored therein.

2. Description of the Related Art

Some image processing apparatus, such as a printer and a multi function machine which are utilized at an office or at home, is connected to an external storage apparatus by a variety of communication units such as USB and TCP/IP, obtains an image file from the external storage apparatus to which the image processing apparatus is connected, and displays or prints the obtained image file. The image file obtained from the external storage apparatus includes a variety of image types and image formats.

On the other hand, some image processing apparatus supports limited image types and image formats because of cost-reduction and down-sizing of hardware. Thus, the image file obtained from the external storage apparatus may not be displayed or be printed.

In this case, the image processing apparatus conventionally notifies a user of an error, or displays or prints an image (hereinafter, referred to as a non-support notice image) which indicates that the image file is not supported by the image processing apparatus.

Such an image processing apparatus is proposed that adds an electronic signature to processed image data and stores the electronic signature when an error is induced in a job flow of a plurality of steps, checks the electronic signature and notifies the user of the electronic signature when the job flow is restarted, and causes the user to select whether or not the job flow is restarted (Japanese Laid-Open Patent Publication (Kokai) No. 2008-78759).

By the way, after the user executes another operation, or demounts the external storage apparatus from the image processing apparatus, the image file may be obtained from the external storage apparatus again, and may be displayed or be printed.

However, when the user is notified of the error, or the non-support notice image is displayed or is printed like the above conventional image processing apparatus, the user can check which file is not supported only while the non-support notice image is being displayed or printed.

Thus, since the not-supported image file may not be checked, it is highly possible that the same error is induced, so that there exists such a problem that the user is caused to execute a useless operation, or a useless processing time is induced because of an image processing error.

### SUMMARY OF THE INVENTION

The present invention provides an image processing apparatus and an image processing method which can cause a user to certainly and quickly recognize a not-supported image file, and a computer-readable storage medium having a program for implementing the method stored therein.

Accordingly, in a first aspect of the present invention, there is provided an image processing apparatus comprising a first determining unit determines whether or not image data capable of being image-processed is included in an image file including a plurality of pieces of image data obtained from outside, an adding unit adds device information including information of non-support to a file header of the image file when it is determined by the first determining unit that image data incapable of being image-processed is included, a second determining unit determines whether or not the device information is included in file header information of the image file obtained from outside, and an image-processing unit image-processes the image file which has been determined by the first determining unit to include image data capable of being image-processed, and the image file which has been determined by the second determining unit not to include the device information in the file header information.

Accordingly, in a second aspect of the present invention, there is provided an image processing method comprising a first determining step of determining whether or not image data capable of being image-processed is included in an image file including a plurality of pieces of the image data obtained from outside, an adding step of adding device information including information of non-support to a file header of the image file when it is determined in the first determining step that image data incapable of being image-processed is included, a second determining step of determining whether or not the device information is included in file header information of the image file obtained from outside, and an image-processing step of image-processing the image file which has been determined in the first determining step to include image data capable of being image-processed, and the image file which has been determined in the second determining step not to include the device information in the file header information.

Accordingly, in a third aspect of the present invention, there is provided a computer-readable storage medium having stored therein a program causing a computer to implement an image processing method, the image processing method comprising a first determining step of determining whether or not image data capable of being image-processed is included in an image file including a plurality of pieces of the image data obtained from outside, an adding step of adding device information including information of non-support to a file header of the image file when it is determined in the first determining step that image data incapable of being image-processed is included, a second determining step of determining whether or not the device information is included in file header information of the image file obtained from outside, and an image-processing step of image-processing the image file which has been determined in the first determining step to include image data capable of being image-processed, and the image file which has been determined in the second determining step not to include the device information in the file header information.

According to the present invention, it becomes possible to cause the user to certainly and quickly recognize the not-supported image file.

The features and advantages of the invention will become more apparent from the following detailed description taken in conjunction with the accompanying drawings.

### BRIEF DESCRIPTION OF THE DRAWINGS

FIG. 1 is a block diagram useful in explaining an example of hardware configuration of an image processing apparatus which is an example of an embodiment of the present invention.

FIG. 2 is a diagram showing an example of configuration of an image file which can be processed by the image processing apparatus.

FIG. 3 is a diagram showing an example of device information described in a file header of the image file.

FIG. 4 is a flowchart useful in explaining an example of an adding process of the device information by the image processing apparatus.

FIG. 5 is a flowchart useful in explaining an example of an analyzing process of the device information by the image processing apparatus.

### DETAILED DESCRIPTION OF THE PREFERRED EMBODIMENTS

An example of an embodiment of the present invention will be described below by referring to the drawings.

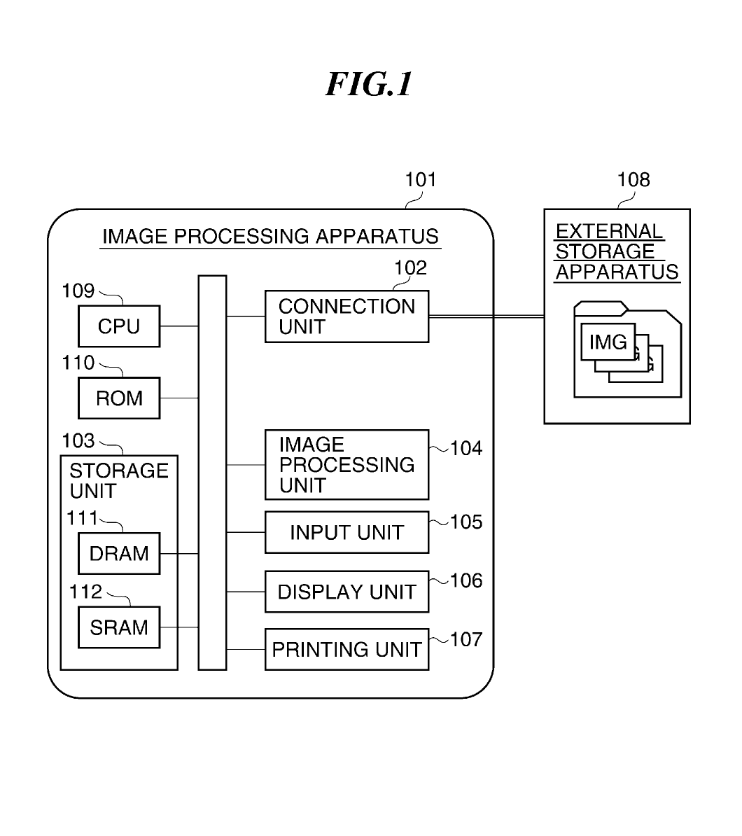

FIG. 1 is a block diagram useful in explaining an exemplary hardware configuration of an image processing apparatus which is an example of the embodiment of the present invention.

As shown in FIG. 1, an image processing apparatus 101 of the present embodiment is provided with a connection unit 102, an image processing unit 104, an input unit 105, a display unit 106, a printing unit 107, a CPU 109, a ROM 110, and a storage unit 103.

The connection unit 102 is a communication interface such as USB and LAN, and is used for communication with an external storage apparatus 108. The image processing apparatus 101 executes data communication with the external storage apparatus 108 through this connection unit 102 and thus can obtain data such as an image file stored in the external storage apparatus 108 and can write data such as the image file in the external storage apparatus 108.

The image processing unit 104 analyzes and image-converts the image file for converting the image file to image data to be displayed in the display unit 106, or converting the image file to the image data to be printed in the printing unit 107. The image processing unit 104 executes image processing such as color processing which is necessary to display the image-converted image data in the display unit 106, and the color processing which is necessary to print the image-converted image data in the printing unit 107.

Here, in the present embodiment, The image data, which can be analyzed and image-converted by the image processing apparatus, is referred to as a supported image, and the image data, which can not be analyzed and image-converted by the image processing apparatus, is referred to as a not-supported image. It is assumed that a type of the image file is a multi page type in which one file can include one or a plurality of images.

The input unit 105 is a user interface unit for accepting an operation instruction by a user, and is, for example, configured with an operation key and the like. When the instruction for displaying or printing the image file stored in the external storage apparatus 108 is issued from the input unit 105, the image processing apparatus 101 obtains the image file through the connection unit 102.

The display unit 106 displays an operation screen, and displays the image data analyzed and image-converted in the image processing unit 104 and the like. It should be noted that the display unit 106 may be configured with an LCD and the like, and a touch panel sheet may be attached on the LCD so that the input unit 105 and the display unit 106 are unified.

The printing unit 107 prints the image data analyzed and image-converted in the image processing unit 104 and the like on a paper medium or the like.

The CPU 109 controls the entire of the image processing apparatus 101. The ROM 110 stores a control program of the CPU 109. The storage unit 103 includes a DRAM 111 and an SRAM 112, and stores the image data of a non-support notice image and the data obtained from the external storage apparatus 108. The DRAM 111 stores a parameter of the control program of the CPU 109. The SRAM 112 stores a buffer for each processing.

Here, in the present embodiment, when the image file can not be analyzed and can not be image-converted in the image processing unit 104, the image data of the non-support notice image stored in the storage unit 103 can be displayed in the display unit 106, or can be printed in the printing unit 107.

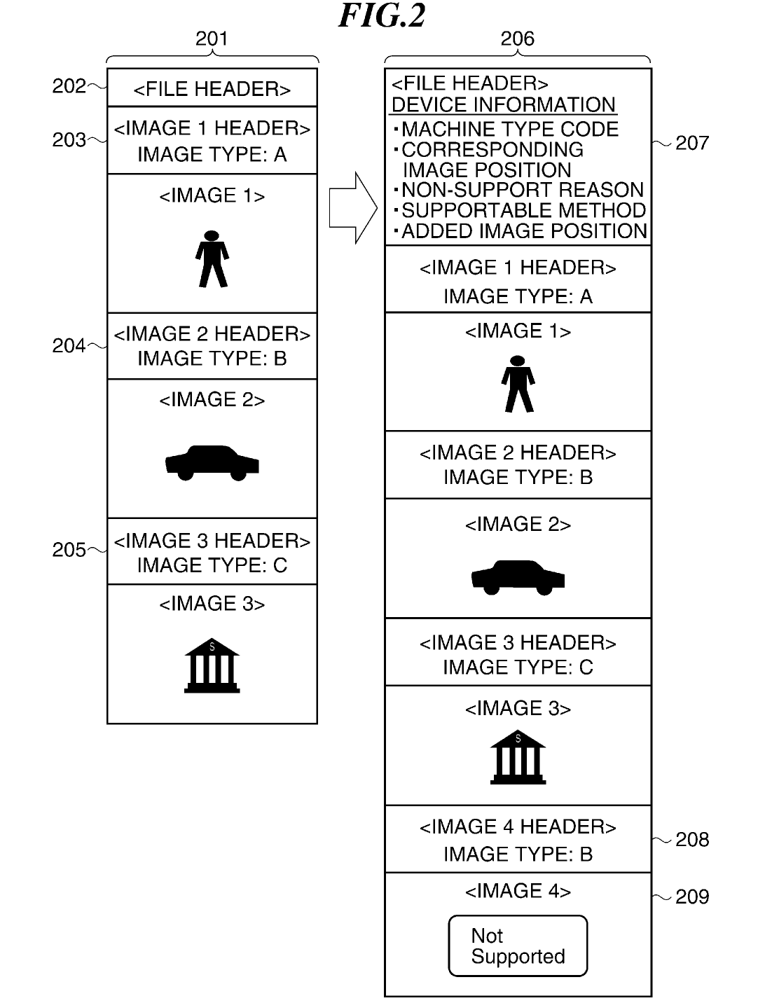

FIG. 2 is a diagram showing an exemplary configuration of the image file which is processed by the image processing apparatus 101 of the present embodiment.

In FIG. 2, an image file 201 is the image file before device information is added, and an image file 206 is the image file after the device information is added. The device information will be described later.

Both of the image file 201 and the image file 206 can include images of a plurality of pages (a plurality of sheets) in one file.

The image file 201 is comprised of a file header 202 arranged at a head portion thereof and three combinations corresponding respectively to images 1 to 3 and arranged in series following the file header 202, each of the combinations consisting of header information and image data. The file header 202 includes configuration information on the entire of the image file 201. The configuration information corresponds to data address in the file for referring to the header information of each of the images 1 to 3, and the like.

A header 203 of the image 1 is the header information of the image 1, and includes image type information of the image 1. A header 204 of the image 2 is the header information of the image 2, and includes the image type information of the image 2. A header 205 of the image 3 is the header information of the image 3, and includes the image type information of the image 3.

Here, in a case of the image file 201, it is assumed that the image type of the image 1 is “A”, the image type of the image 2 is “B”, and the image type of the image 3 is “C”. The image type, for example, corresponds to an image format such as JPEG and a bitmap. Further, in the JPEG, the finer type may be adopted as the image type, such as a baseline type, a progressive type, and a lossless type as a compression method, and an RGB type and a YUV type as a color component type.

In the image file which can be processed by the image processing apparatus 101 of the present embodiment, as described above, one file may be configured from the image data of a plurality of pages (a plurality of sheets), and the image type of the image data of each page may be different from each other.

For example, such a case will be considered that the image processing apparatus 101 obtains the image file 201 from the external storage apparatus 108, and displays the obtained image file 201 in the display unit 106, or prints the obtained image file 201 in the printing unit 107.

The image processing apparatus 101 analyzes the file header 202 of the obtained image file 201, the header 203 of the image 1, the header 204 of the image 2, and the header 205 of the image 3 in the image processing unit 104, and converts each image to the image data for displaying or printing each image.

Here, such a case will be assumed that the image type supported by the image processing apparatus 101 is only the “B”.

The image processing unit 104 adds the device information to the file header 202 of the image file, and causes the added device information to be a file header 207. A detail of the device information added to the file header 207 will be described later.

The image processing unit 104 can also add the image data of the non-support notice image stored in the storage unit 103 as the image of the next page.

The non-support notice image is, for example, the image for enabling “Not Supported” such as image data 209 to be displayed, or to be print-outputted. An image 4 to be added includes a header 208 of the image 4 and an image data 209 of the image 4. The image type of the image data 209 is the image type B which can be analyzed and can be image-converted by the image processing apparatus 101.

When displaying or printing the image based on the image file 206, the image processing apparatus 101 executes displaying or printing process for the image after referring to the device information of the file header 207. The detail will be described later.

When the image file 206 is displayed in other apparatuses such as a PC, the added image data 209 of the image 4 can also be displayed in association with the image 1 and the image 3 by using the device information of the file header 207. Thereby, even when the image is not displayed or is not printed in the image processing apparatus 101, a user can determines whether the image file 206 includes the not-supported image, and which image data of the image file 206 is the not-supported image.

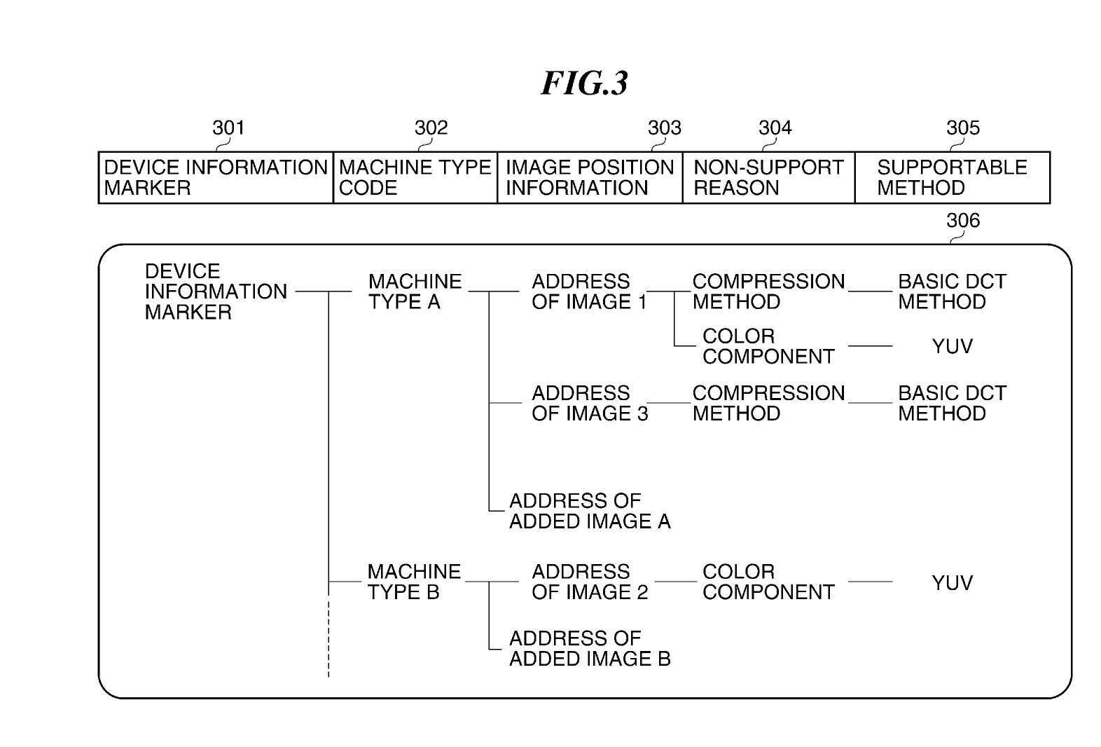

FIG. 3 is a diagram showing an example of the device information described in the file header 207 of the image file 206.

In FIG. 3, a device information marker 301 indicates that the device information is described in the file header 207, and is referred to when the image file is analyzed by the image processing unit 104.

A machine type code 302 indicates a type of the image processing apparatus which has obtained the image file, and executed some outputting process (printing process, displaying process, and the like). In the present embodiment, when the image file, which can not be processed, is included because the image file obtained by the image processing apparatus includes a not-supported image, a broken file, or the like, the machine type code of the corresponding image processing apparatus is recorded in the file header of the obtained image file. It should be noted that in the present embodiment, it is assumed that the image processing apparatus of the same machine type code includes the same image processing capability. That is, it is assumed that the type of the supported image/not-supported image is also the same in the image processing apparatus of the same machine type code.

Image position information 303 indicates a data address in the file of image header information of the not-supported image included in the image file, and is referred to when the image file is analyzed by the image processing unit 104. As described in FIG, 2, when the non-support notice image is added, the image position information 303 can include information on data position of the image header information of the non-support notice image and indicating the fact that the image is the non-support notice image.

A non-support reason 304 indicates a reason why the image processing apparatus 101 can not analyze and image-convert the not-supported image, and is indicated by image type information, image conversion error information, and the like. The image type information is the image type information which can arbitrarily designate the compression method, a color component, and the like when the image file is, for example, JPEG. The image conversion error information is, for example, error information for indicating that an error has been induced during the decoding of the image data because of the broken original image data or the like. The non-support reason 304 is referred to for non-support determination when the image file is analyzed, and information notice when the image file is displayed in other apparatuses.

A support capability method 305 indicates the image type information which can be supported by the image processing apparatus for the image type information of the non-support reason 304, and is referred to for the information notice when the image file is displayed in other apparatuses.

In the lower side of the device information 301 to 305 of FIG. 3, device information structure 306 is shown based on a format of the device information 301 to 305.

A plurality of the machine type codes 302 may be included for the device information marker 301. When the image file, to which the device information is added in a machine type A, is displayed or is printed in another machine type B, the device information is added to the machine type code 302.

A plurality of pieces of the image position information 303 may be included for the machine type code 302. When a plurality of pieces of the image data of the image file are the not-supported images, the device information is added to the image position information 303 for each image data. As described in FIG. 2, when the non-support notice image is added, the image position information 303 of the non-support notice image is added.

A plurality of the non-support reasons 304 may be included for the image position information 303. When a plurality of the non-support reasons are included for one image data in a case where the image file is analyzed, the device information is added to each of the non-support reasons 304. One of the support capability methods 305 is set for one non-support reasons 304.

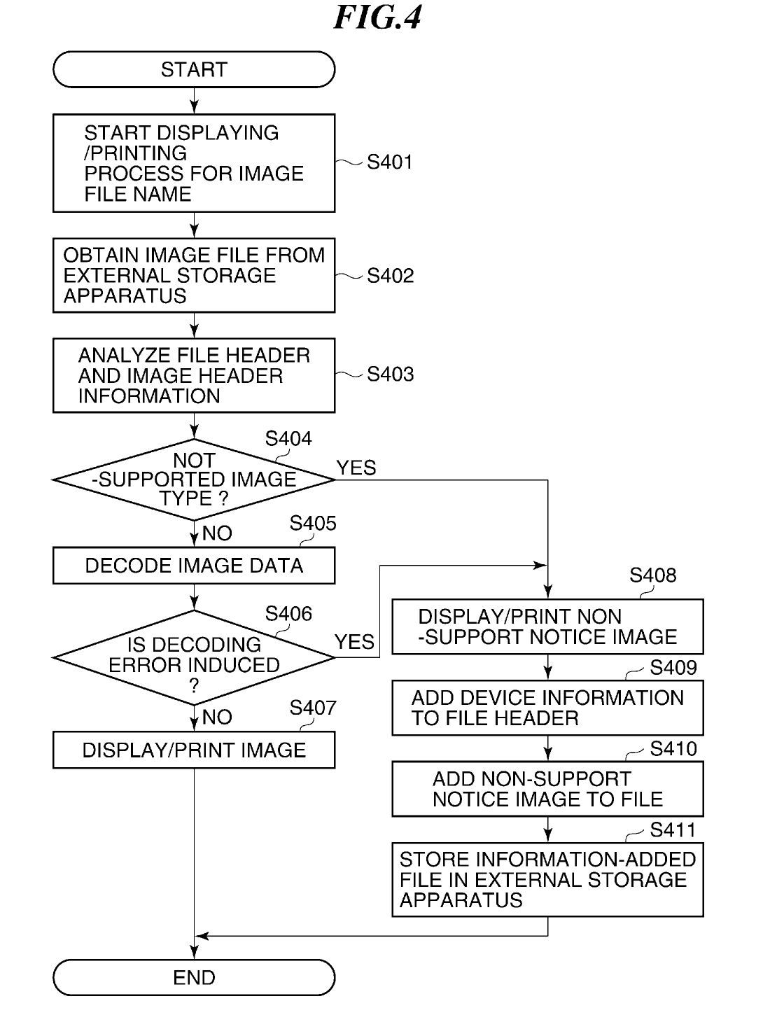

Next, an example of an adding process of the device information by the image processing apparatus of the present embodiment will be described by referring to FIG. 4. Each process of FIG. 4 is executed by the CPU 109 after loading a program stored in the ROM 110 or the like to a RAM.

In step S401, the CPU 109 obtains file information of the image file from the external storage apparatus 108 through the connection unit 102, and displays a list of file names in the display unit 106. The CPU 109 accepts an instruction of the file name selected by the user in the input unit 105 among the file names list-displayed in the display unit 106, and accepts a request for displaying or printing the image file specified by the selected file name.

Here, the file information includes information on the file name including an extension and file size, and is utilized for displaying the file name.

Next, in step S402, the CPU 109 obtains the image file from the external storage apparatus 108 through the connection unit 102, and stores the obtained image file in the storage unit 103.

Next, in step S403, the CPU 109 controls the image processing unit 104, and analyzes the file header and the image header information of the image file obtained in step S402. In an analyzing process in step S403, the image type information included in the image header information is referred to. When the image data of a plurality of pages is included in the image file, the image header information of each page is analyzed.

Next, in step S404, the CPU 109 (first determining unit) determines whether or not the image type information analyzed in step S403 is the not-supported image with respect to the image processing capability of the image processing unit 104.

When the CPU 109 determines that the image type information analyzed in step S403 is the supported image (when the image file includes the image data of a plurality of pages, every image data is the supported image), the CPU 109 proceeds to step S405. When the CPU 109 determines that the image type information analyzed in step S403 is the not-supported image (when the image file includes the image data of a plurality of pages, the not-supported images of at least one or more pages are included), the CPU 109 proceeds to step S408.

In step S405, the CPU 109 controls the image processing unit 104, executes a decoding process of the image data to display or print the image data, and proceeds to step S406.

In step S406, when the decoding process is normally completed in step S405, the CPU 109 proceeds to step S407, and when some error is induced during the decoding process, the CPU 109 proceeds to step S408.

In step S407, the CPU 109 executes the image process such as color processing which is necessary to display or print in the image processing unit 104 on the image data decoded in step S405. The CPU 109 displays the image-processed image data in the display unit 106, or prints the image-processed image data on the paper medium or the like in the printing unit 107, and completes the process.

In step S408, the CPU 109 executes the image process such as the color processing which is necessary to display or print in the image processing unit 104 on the non-support notice image stored in the storage unit 103. The CPU 109 displays the image-processed non-support notice image in the display unit 106, or prints the image-processed non-support notice image on the paper medium or the like in the printing unit 107, and proceeds to step S409.

In step S409, the CPU 109 adds the device information to the file header of the image file stored in the storage unit 103 in step S402, and proceeds to step S410. This device information includes the non-support reason (the not-supported image, and a decode error) obtained in step S404 and step S406.

In step S410, the CPU 109 adds the non-support notice image displayed or printed in step S408 to the image file of step S409, and proceeds to step S411.

In step S411, the CPU 109 transfers the image file of step S410 to the external storage apparatus 108 through the connection unit 102, and stores the transferred image file. In this case, the CPU 109 may overwrite and store the image file transferred to the external storage apparatus 108, or may store the transferred image file as another file.

In the present embodiment, by executing the process of FIG. 4, the non-support notice image of step S410 can be displayed when the image file stored in the external storage apparatus 108 in step S411 is displayed by the PC or other apparatuses. Thereby, such a fact can be recognized that the not-supported image is included in the image processing apparatus 101.

By concurrently notifying contents of the device information of step S409, it can be checked which image data in the image file is not supported because of what reason in the image processing apparatus of what machine type.

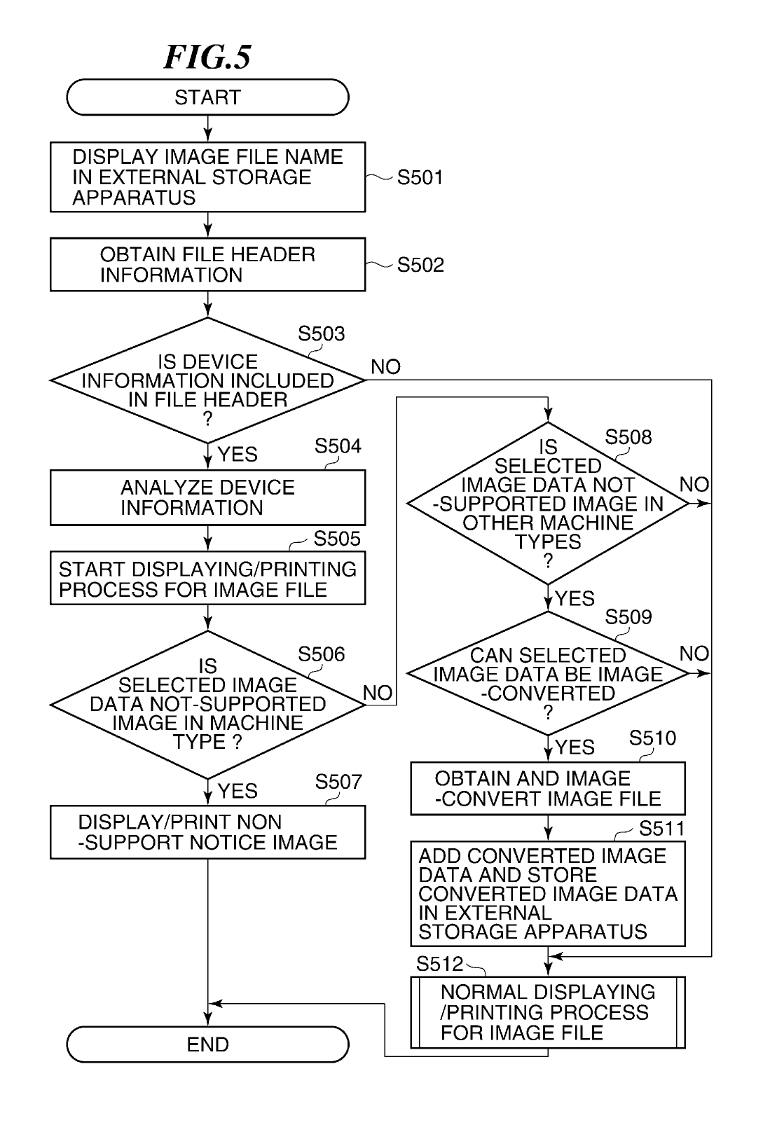

Next, an example of the analyzing process for the device information by the image processing apparatus 101 of the present embodiment will be described by referring to FIG. 5. Each process of FIG. 5 is executed by the CPU 109 by loading the program stored in the ROM 110 or the like to the RAM.

In step S501, the CPU 109 obtains the file information of the image file in the external storage apparatus 108 through the connection unit 102, displays the file name in the display unit 106, and proceeds to step S502.

In step S502, the CPU 109 obtains only file header information for the image file in the external storage apparatus 108 through the connection unit 102, stores the obtained file header information in the storage unit 103, and proceeds to step S503.

In step S503, the CPU 109 (second determining unit) determines whether or not the device information is included in the file header information by retrieving the device information marker 301 from the file header information.

When the device information is included in the file header information, the CPU 109 proceeds to step S504, and when the device information is not included in the file header information, the CPU 109 proceeds to step S512.

In step S504, the CPU 109 controls the image processing unit 104, analyzes the device information based on the format shown in FIG. 3, determines whether the not-supported image is included, and proceeds to step S505.

Here, the CPU 109 (third determining unit) determines whether the not-supported image is dedicated to the machine type or dedicated to other machine types. When the machine type code 302 corresponding to the image processing apparatus 101 is included, the CPU 109 stores the image position information 303, which is the device information following the machine type code 302, in the storage unit 103. Further, when the machine type code 302 does not correspond to the image processing apparatus 101, the CPU 109 stores the image position information 303, the non-support reason 304, and the support capability method 305, which are the device information following the machine type code 302, in the storage unit 103.

In step S505, the CPU 109 starts the displaying or printing process, which is requested from the input unit 105, for the image file stored in the external storage apparatus 108, and proceeds to step S506.

In step S506, when it is determined in step S504 that the image data requested in step S505 is the not-supported image in the machine type, the CPU 109 proceeds to step S507, and in the other case, the CPU 109 proceeds to step S508.

In step S507, the CPU 109 executes the image processing such as the color processing, which is necessary to display or print in the image processing unit 104, for the non-support notice image stored in the storage unit 103.

The CPU 109 displays the image-processed non-support notice image in the display unit 106, or prints the image-processed non-support notice image on the paper medium or the like in the printing unit 107, and completes the process.

On the other hand, in step S508, when it is determined in step S504 that the image data requested in step S505 is the not-supported image in other machine types, the CPU 109 proceeds to step S509, and in the other case, the CPU 109 proceeds to step S512.

In step S509, the CPU 109 (fourth determining unit) determines whether the image data requested in step S505 can be image-converted according to the support capability method 305 by referring to the device information stored in the storage unit 103 in step S504.

When determining that the image data requested in step S505 can be image-converted, the CPU 109 proceeds to step S510, and in other case, the CPU 109 proceeds to step S512.

In step S510, the CPU 109 obtains the image file from the external storage apparatus 108 through the connection unit 102, and stores the obtained image file in the storage unit 103. The CPU 109 image-converts the image data requested in step S505 according to the determination in step S509, and proceeds to step S511.

In step S511, the CPU 109 transfers the image file, to which the image data image-converted in step S510 is added, to the external storage apparatus 108 through the connection unit 102, stores the transferred image file in the external storage apparatus 108, and proceeds to step S512. In this case, the CPU 109 may overwrite and store the image file transferred to the external storage apparatus 108, or may store the transferred image file as another file.

In step S512, the CPU 109 executes the normal displaying process and printing process for the image file, that is, the processes after step S402 in FIG. 4, and completes the process.

In the present embodiment, when the non-support notice image is displayed or is printed by the machine type by executing the process of FIG. 5, since the not-supported image is determined in advance, when the displaying or the printing is started, it is not necessary to analyze or image-convert each image data. That is, it becomes unnecessary to analyze the header information 203, 204, and 205 of the image data. Thereby, the non-support notice image can be quickly displayed or printed.

When the non-support notice image of other machine types is displayed or is printed, by image-converting the non-support notice image to the image type requested by other machine types, and adding the image-converted non-support notice image to the image file, it also becomes possible to display or print the non-support notice image in other machine types.

It should be noted that the present invention is not limited to the above-exemplified embodiment, but can be arbitrarily changed without departing from the scope of the concept of the present invention.

For example, while such a case is exemplified in the above embodiment that the image file or the non-support notice image is displayed or is printed, the image file or the non-support notice image may be displayed and be also printed.

It is to be understood that the objects of the present invention may also be accomplished by supplying a system or an apparatus with a storage medium in which a program code of software which realizes the functions of the above described embodiments is stored, and causing a computer (or CPU or MPU) of the system or apparatus to read out and execute the program code stored in the storage medium.

In this case, the program code itself read from the storage medium realizes the functions of any of the embodiments described above, and hence the program code and the storage medium in which the program code is stored therein constitute the present invention.

Examples of the storage medium for supplying the program code include a floppy (registered trademark) disk, a hard disk, a magnetic-optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program code may be downloaded via a network.

Further, it is to be understood that the functions of the above described embodiments may be accomplished not only by executing a program code read out by a computer, but also by causing an OS (operating system) or the like which operates on the computer to perform a part or all of the actual operations based on instructions of the program code.

Further, it is to be understood that the functions of the above described embodiments may be accomplished by writing a program code read out from the storage medium into a memory provided on an expansion board inserted into a computer or in an memory provided expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-218103 filed Aug. 27, 2008, which is hereby incorporated by reference herein in its entirety.

What is claimed is:

1. An image processing apparatus, comprising:
a first determining unit adapted to determine whether or not image data capable of being image-processed is included in an image file including a plurality of pieces of image data obtained from outside;
an adding unit adapted to add device information including information of non-support to a file header of the image file when it is determined by said first determining unit that image data incapable of being image-processed is included;
a second determining unit adapted to determine whether or not the device information is included in file header information of the image file obtained from outside; and
an image-processing unit adapted to image-process the image file which has been determined by said first determining unit to include image data capable of being image-processed, and the image file which has been determined by said second determining unit not to include the device information in the file header information.

2. The image processing apparatus according to claim 1, further comprising:
an outputting unit adapted to output an image for notifying a fact of non-support when it is determined by said first determining unit that image data incapable of being image-processed is included, and when it is determined by said second determining unit that the device information is included in the file header information.

3. The image processing apparatus according to claim 2, wherein
said outputting unit outputs the image for notifying the fact of non-support to at least one of a display unit and a printing unit.

4. The image processing apparatus according to claim 1, further comprising:
a third determining unit adapted to determine whether or not the device information is dedicated to other image processing apparatuses when it is determined by said second determining unit that the device information is included in the file header information; and
a fourth determining unit adapted to determine whether or not the image of the image file including the device information can be processed when it is determined by said third determining unit that the device information is dedicated to other image processing apparatuses,
wherein said image-processing unit image-processes the image of the image file including the device information obtained from outside when it is determined by said fourth determining unit that the image can be processed.

5. The image processing apparatus according to claim 1, wherein
said first determining unit processes each of the image data of a plurality of pages included in the image file obtained from outside.

6. An image processing method, comprising:
a first determining step of determining whether or not image data capable of being image-processed is included in an image file including a plurality of pieces of the image data obtained from outside;
an adding step of adding device information including information of non-support to a file header of the image file when it is determined in said first determining step that image data incapable of being image-processed is included;
a second determining step of determining whether or not the device information is included in file header information of the image file obtained from outside; and
an image-processing step of image-processing the image file which has been determined in said first determining step to include image data capable of being image-processed, and the image file which has been determined in said second determining step not to include the device information in the file header information.

7. A computer-readable storage medium having stored therein a program causing a computer to implement an image processing method, the image processing method comprising:
a first determining step of determining whether or not image data capable of being image-processed is included in an image file including a plurality of pieces of the image data obtained from outside;
an adding step of adding device information including information of non-support to a file header of the image file when it is determined in said first determining step that image data incapable of being image-processed is included;
a second determining step of determining whether or not the device information is included in file header information of the image file obtained from outside; and
an image-processing step of image-processing the image file which has been determined in said first determining step to include image data capable of being image-processed, and the image file which has been determined in said second determining step not to include the device information in the file header information.
